(19) United States
(12) Patent Application Publication
(10) Pub. No.: US 2020/0316448 A1
(43) Pub. Date: Oct. 8, 2020

(54) GOLF CLUB TRAINING DEVICE TO IMPROVE CONTACT WITH A GOLF BALL

(71) Applicants: Joshua Bowmar, Ankeny, IA (US); Jeromey Bowmar, Ankeny, IA (US)

(72) Inventors: Joshua Bowmar, Ankeny, IA (US); Jeromey Bowmar, Ankeny, IA (US)

(21) Appl. No.: 16/843,651

(22) Filed: Apr. 8, 2020

Related U.S. Application Data
(60) Provisional application No. 62/830,553, filed on Apr. 8, 2019.

(51) Int. Cl. A63B 69/36; A63B 53/04; F21V 33/00

(52) U.S. Cl. CPC A63B 69/3632; F21Y 2115/10; F21V 33/008; A63B 53/0466

(57) ABSTRACT

A lighting device attached to the head of a golf club. The lighting device can include a housing body, one or more lighting sources, battery and circuitry. The lighting device is attached to the top of the club head such that the light sources are axially aligned with the sweet spot of the face of the club head. As the head of the club is swung toward the ball, a line of light is seen or perceived by the user due to the emitting light sources, defining a target swing path and contact point for the golf ball and the sweet spot.

### PRIORITY

This Application claims priority to and the benefit of U.S. Provisional Patent Application No. 62/830,553, filed Apr. 8, 2019, which is incorporated fully herein by reference.

### FIELD

The present invention relates generally to golf clubs and, more particularly, to a device attached to or otherwise provided with a golf club to improve contact accuracy with a golf ball.

### BACKGROUND

Various teaching aids and devices exist to address, and attempt to improve, the swing of a golfer. While many of these aids and devices focus on the form of the golfer's swing, they do not typically assist in improving a key aspect of any good golf swing: ensuring that the golf club makes precise contact with the ball at the “sweet spot” of the face of the club head with the club head in the correct alignment towards the target for the ball's flight.

The sweet spot of the club face can be slightly different for every club and simply defines the point where, as one strikes the golf ball, the center of gravity of the club head is moving directly towards the center of gravity of the golf ball. Hitting the ball at this sweet spot enables the golfer to get maximum ball speed while avoiding twisting of the club head at impact (i.e. alignment at impact). Missing the sweet spot, even by a very small amount, imparts spin on the ball, which negatively impacts speed, distance, direction and curvature of the ball's flight.

Accordingly, there is a need for new and improved devices and methods to solve the innate issues surrounding precise contact of a golf club with a golf ball at the sweet spot.

### SUMMARY

Embodiments of the present invention comprise a lighting device attached to the head of a golf club. The lighting device can include a housing body, one or more light sources, and circuitry and components. The lighting device is attached to the top of the club head such that the light source(s) are axially aligned with a sweet spot of the face. When the light sources are activated the act of the user swinging the head of the club toward the ball creates a line of light visible to the user due to the light source emission while the club head is moving rapidly. This line of light defines the swing path of the club head through its sweet spot so that the user can align the line of light with the ball to be struck so that optimum contact with the ball can be achieved. The user thus can appreciate their swing path with respect to the ball that ordinarily is very difficult to appreciate given the relative size and color of the club head moving rapidly toward the ball. The user can therefore make adjustments to their swing to repeatedly achieve the optimum swing path and build muscle memory and mental perception. In other words, the user can train better and achieve better results from their training. The lighting device can be removed and reattached to the head as needed, or removed and attached to another golf club.

When two light sources are provided to the lighting device, the two aligned lights will appear as a single light or light path when the user is correctly swinging their golf club such that the ball contacts the sweet spot of the club face with the correct alignment. However, if the user is swinging the club with an incorrect head alignment (or orientation of club face) (e.g., a slightly closed or opened club face), the user will see two separate light paths.

The disclosure includes a golf training device to improve contact of a head of a golf club with a golf ball by a golfer when swinging the golf club. The golf training device may include a housing defining an enclosed interior, and first and second light sources disposed inside of the enclosed interior and oriented to project light upward from the housing. The first light source is located adjacent a first longitudinal end of the housing and the second light source is disposed adjacent to a second longitudinal end of the housing such that the first light source and second light source are longitudinally spaced apart from one another along an axis that is alignable with a sweet spot on a face of the head of the golf club when the housing is secured to the head of the golf club.

The first and second light sources can be longitudinally spaced apart from one another along the axis sufficient to define a respective first line of light and a respective second line of light when the golf club having the golf training device attached is swung by the user incorrectly.

The disclosure further includes a golf training system. The system may include a lighting device secured atop a golf club head. A golf club comprises a golf club head secured to a shaft. The golf club head defines a face with a sweet spot for striking a golf ball. The lighting device secured atop the golf club head comprises a housing defining an enclosed interior, a first light source disposed inside of the enclosed interior and oriented to project light upward from the housing, and a second light source disposed inside of the enclosed interior and oriented to project light upward from the housing. The first light source is located adjacent a first longitudinal end of the housing and the second light source is disposed adjacent to a second longitudinal end of the housing such that the first light source and second light source are longitudinally spaced apart from one another along an axis that is aligned with the sweet spot of the face of the golf club head.

Again the first light source and second light source can be longitudinally spaced apart from one another along the axis sufficient to define a respective first line of light and a respective second line of light when the golf club is swung by a user incorrectly.

The disclosure also includes a method of improving contact of a head of a golf club with a golf ball by a golfer when swinging the golf club. The method includes securing a lighting device atop the head of the golf club, illuminating a first light source disposed inside of the lighting device, illuminating a second light source disposed inside of the lighting device, defining a first line of light and a second line of light, spaced apart from the first line of light, when the golfer swings the club towards the ball incorrectly, and defining only a single line of light when the golfer swings the club towards the ball correctly.

The golfer swinging the club towards the ball incorrectly can include a closed club face orientation and an open club face orientation.

The above summary is not intended to describe each illustrated embodiment, claimed embodiment or implementation of the invention. The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

The invention may be more completely understood in consideration of the following detailed description of various embodiments of the invention in connection with the accompanying drawings, in which:

FIG. 1 shows a user's partial perspective view of a golf aid lighting device attached to the head of a golf club, in accordance with embodiments of the present invention.

FIG. 2 shows a partial perspective view of a golf aid lighting device attached to the head of a golf club from the rear side of the club head, in accordance with embodiments of the present invention.

FIG. 3 is the view of FIG. 1 including a line of light, in accordance with embodiments of the present invention.

FIG. 4 is the view of FIG. 1 including dual lines of light, in accordance with embodiments of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the invention is to cover all modifications, equivalents, and alternatives falling within the spirit and scope of the invention as defined by the appended claims.

### DETAILED DESCRIPTION

In the following descriptions, the present invention will be explained with reference to example embodiments thereof. However, these embodiments are not intended to limit the present invention to any specific example, embodiment, environment, applications or particular implementations described in these embodiments. Therefore, description of these embodiments is only for purpose of illustration rather than to limit the present invention.

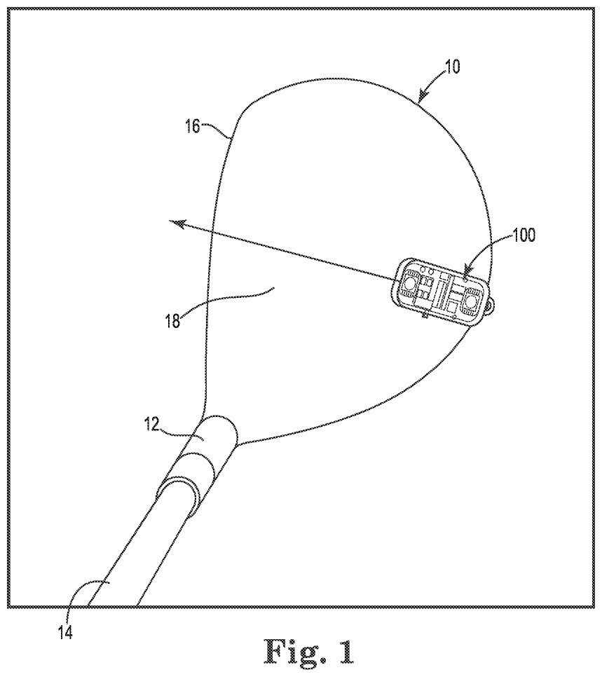

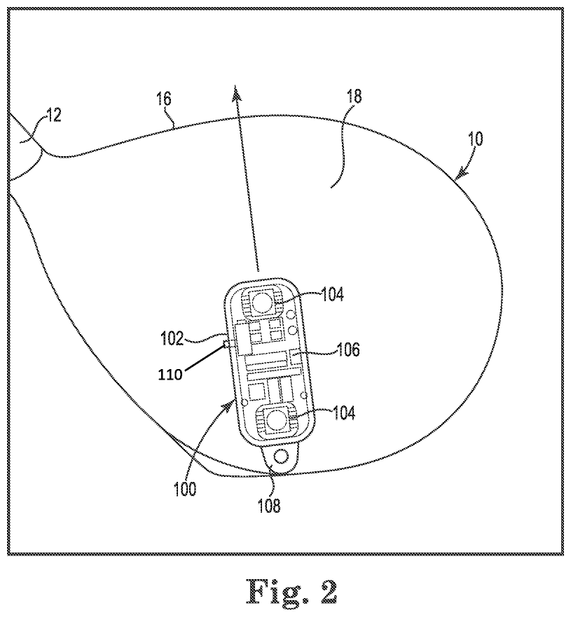

Referring generally to FIGS. 1-2, a lighting device 100 for improving contact accuracy between a golf club and a golf ball is provided. The device 100 can include a housing or body portion 102 that defines an enclosure, one or more light sources 104 disposed within the enclosure, electronic control circuitry 106 and a power source (e.g. battery).

The lighting device 100 can be attached to, and removed from, the head 10 of a golf club. The lighting device can be secured to the head 10 with double-sided stick tape, glue or with a mechanical fastener.

The golf club further includes a shaft 14 and a hose) 12 extending from the head 10. The head 10 includes a face 16 and a top or crown surface 18. It is this top surface 18 of the head 10 that the lighting device 100 is attached to, such that the axial alignment of the light sources 104 correspondingly aligns with the sweet spot on the head face 16—as shown with an arrowed line in the figures.

The one or more light sources 104 can comprise ultra-bright light emitting diodes (LEDs) 104. The LED's can be white or any other desired color. The embodiment depicted in FIGS. 1-2 includes two light sources. However, other embodiments can include a single light source 104 or more than two light sources 104, and can include sources other than LED devices.

As shown in FIG. 2, the two light sources 104 are axially aligned with one another and located adjacent the opposing longitudinal end portions of the body 102, with a gap defined therebetween—e.g., ½ inch.

The housing body 102 can be approximately 1 inch in length, in certain embodiments, and houses the light sources 104, electronic circuitry and components 106, such as a motherboard, a power switch, a battery, and the like. The body 102 can be constructed of a lightweight material, such as plastic. The body can be formed, for example, as a two-piece cover and base wherein the cover is transparent at least where the light can project from the light sources 104. The housing body can comprise a planar top and bottom surface. Alternatively, the bottom, or both of the top and bottom surfaces can be curved to follow the curved contour of the golf club head.

The bottom surface of the body 102 can receive the tape adhesive, or other material, structures, or techniques to permit selective attachment to, and removal from, the club head 10. Further, a tab 108 or like protrusion or feature can be included to facilitate manual manipulation of the device 100.

An on/off switch 110 can be provided to the housing body 102. In the embodiment depicted in FIGS. 1-2, the on/off switch 110 is a push button that projects laterally outward from a side wall of the housing 102. Other on/off switch embodiments can be provided as well. For example, a membrane switch can be provided to the housing that will turn the light sources 104 on/off when depressed.

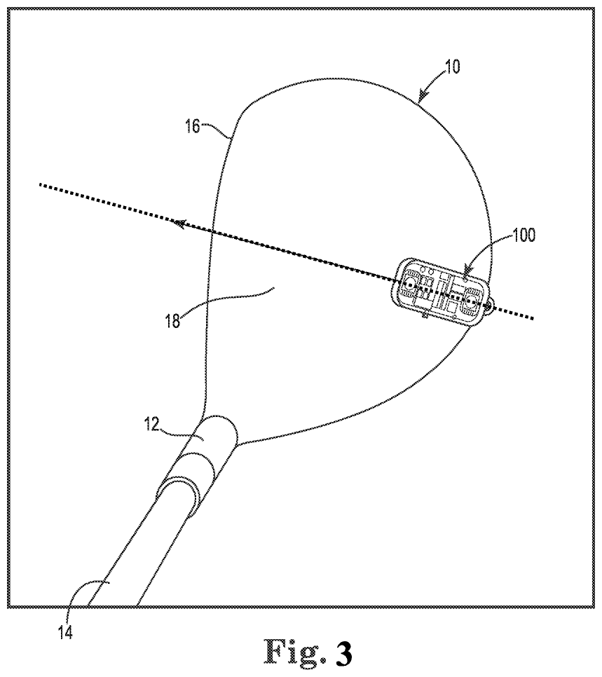

In use, the device 100 is attached to the top 18 of the head 10 such that the light sources 104 are axially aligned with the sweet spot on the face 16, as detailed herein. As the head 10 of the club is swung toward the ball, a line of light (dashed line in FIG. 3) is seen or perceived by the user due to the emitting light sources 104; again, a line that is exactly aligned with the desired sweet spot on the face 16. As such, the user sees a target path for the swing to ensure proper and exact contact of the sweet spot with the ball.

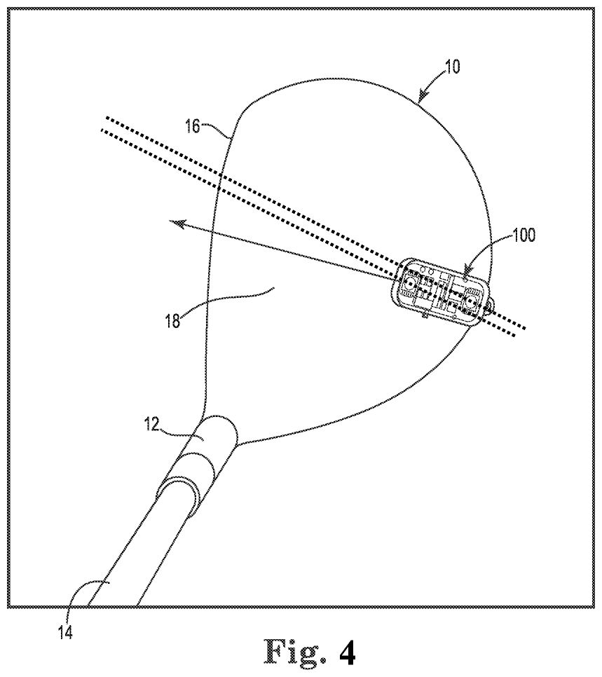

If the user is correctly swinging the golf club such that the ball contacts the sweet spot of the club face, the two aligned lights will appear as a single line or light path (single dashed line in FIG. 3). However, if the user is swinging the club incorrectly (e.g., a slightly closed or opened club face), the user will see two separate lines or light paths (e.g., dual dashed lines in FIG. 4). Embodiments with three or more LEDs spaced apart will show a corresponding number of light lines when the club head is not correctly aligned when swung.

The user can, therefore, make fine or micro-adjustments to the swing, build up advantageous muscle memory, and train their mind on the ideal swing and contact point. The light device 100 can be removed, positionally adjusted, and reattached to the head 10 as needed, or removed and attached to the head of another golf club.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features, components, elements, or aspects of various example embodiments may be mixed and matched (even if such combination is not explicitly described herein) without departing from the spirit and scope of the invention.

What is claimed is:

1. A golf training device to improve contact of a head of a golf club with a golf ball by a golfer when swinging the golf club, the golf training device comprising:
a housing defining an enclosed interior;
a first light source disposed inside of the enclosed interior and oriented to project light upward from the housing; and
a second light source disposed inside of the enclosed interior and oriented to project light upward from the housing;
wherein the first light source is located adjacent a first longitudinal end of the housing and the second light source is disposed adjacent to a second longitudinal end of the housing such that the first light source and second light source are longitudinally spaced apart from one another along an axis that is alignable with a sweet spot on a face of the head of the golf club when the housing is secured to the head of the golf club.

2. The golf training device of claim 1, wherein the first light source and the second light source are each light emitting diodes (LEDs).

3. The golf training device of claim 1, further including a tape layer disposed to a bottom surface of the housing.

4. The golf training device of claim 1, further comprising an on/off switch projecting outwardly from the housing.

5. The golf training device of claim 4, wherein the on/off switch is a button that extends laterally outward from the housing.

6. The golf training device of claim 1, wherein there are only two light sources disposed within the housing.

7. The golf training device of claim 1, wherein an upper surface of the housing is transparent, and wherein an opposing lower surface of the housing faces the head of the golf club.

8. The golf training device of claim 1, wherein the first light source and second light source are longitudinally spaced apart from one another along the axis by at least ¹/₂ inch.

9. The golf training system of claim 1, wherein the first light source and second light source are longitudinally spaced apart from one another along the axis sufficient to define a respective first line of light and a respective second line of light when the golf club having the golf training device attached is swung by the user incorrectly.

10. A golf training system, comprising:
a golf club comprising a golf club head secured to a shaft, the golf club head defining a face with a sweet spot for striking a golf ball; and
a lighting device secured atop the golf club head, the lighting device comprising:
a housing defining an enclosed interior;
a first light source disposed inside of the enclosed interior and oriented to project light upward from the housing; and
a second light source disposed inside of the enclosed interior and oriented to project light upward from the housing;
wherein the first light source is located adjacent a first longitudinal end of the housing and the second light source is disposed adjacent to a second longitudinal end of the housing such that the first light source and second light source are longitudinally spaced apart from one another along an axis that is aligned with the sweet spot of the face of the golf club head.

11. The golf training system of claim 10, wherein the first light source and second light source are longitudinally spaced apart from one another along the axis sufficient to define a respective first line of light and a respective second line of light when the golf club is swung by a user incorrectly.

12. The golf training system of claim 10, wherein the first light source and the second light source are each LEDs.

13. The golf training system of claim 10, wherein the lighting device is secured atop the golf club head via a layer of tape disposed between the housing of the lighting device and the golf club head.

14. The golf training device of claim 10, further comprising an on/off switch projecting outwardly from the housing.

15. The golf training device of claim 14, wherein the on/off switch is a button that extends laterally outward from the housing.

16. The golf training device of claim 10, wherein there are only two light sources disposed within the housing.

17. The golf training device of claim 10, wherein an upper surface of the housing is transparent, and wherein an opposing lower surface of the housing faces the head of the golf club.

18. A method of improving contact of a head of a golf club with a golf ball by a golfer when swinging the golf club, the method comprising:
securing a lighting device atop the head of the golf club;
illuminating a first light source disposed inside of the lighting device;
illuminating a second light source disposed inside of the lighting device;
defining a first line of light and a second line of light, spaced apart from the first line of light, when the golfer swings the club towards the ball incorrectly; and
defining only a single line of light when the golfer swings the club towards the ball correctly.

19. The method of claim 18, wherein the golfer swinging the club towards the ball incorrectly includes a closed club face orientation and an open club face orientation.

20. The method of claim 18, further comprising pushing a button of the lighting device to turn the first light source and the second light source on or off.
